(19) United States
(12) Patent Application Publication
(10) Pub. No.: US 2023/0020449 A1
(43) Pub. Date: Jan. 19, 2023

(54) DEVICE FOR CALCULATING FIRE INSURANCE PREMIUM DISCOUNT RATE FOR DISTRIBUTION BOARD

(71) Applicant: LS ELECTRIC CO., LTD., Anyang-si, Gyeonggi-do (KR)

(72) Inventor: Ho Young KANG, Anyang-si Gyeonggi-do (KR)

(21) Appl. No.: 17/784,934

(22) PCT Filed: Apr. 2, 2020
(86) PCT No.: PCT/KR2020/004485

§ 371 Date: Jun. 13, 2022

(30) Foreign Application Priority Data
Dec. 13, 2019 (KR) 10-2019-0167050

(51) Int. Cl. G06Q 30/02; G06Q 40/08

(52) U.S. Cl. CPC G06Q 30/0211; G06Q 40/08

(57) ABSTRACT

The present disclosure relates to a device that calculates a fire insurance premium discount rate applied to a distribution board so as to provide the same to an insurance company server, and provides a device for calculating a fire insurance premium discount rate for a distribution board, comprising: a control unit for receiving distribution board information from the distribution board and controlling the distribution board; and a discount rate calculation unit for receiving, from the insurance company server, fire insurance premium information applied to the distribution board, and calculating a discount rate of the fire insurance premium on the basis of the distribution board information and the fire insurance premium information.

### CROSS-REFERENCE TO RELATED APPLICATIONS

This application is a National Stage of International Application No. PCT/KR2020/003605 filed on Mar. 16, 2020, claims priority to and the benefit of Korean Patent Application No. 10-2019-0159109, filed on Dec. 3, 2019, the disclosure of which is incorporated herein by reference in its entirety.

### FIELD

The present disclosure relates to a device for calculating a fire insurance premium discount rate for a distribution board.

### BACKGROUND

A distribution board is a device that facilitates the control of supply of electricity by disposing a measuring device and a sensor in buildings or the like in which electrical facilities are provided, such as power plants, substations, general buildings and the like. That is, the distribution board is a device that monitors, controls and protects the supply of electricity by adjusting electricity supplied from the outside to an appropriate level in the corresponding building or the like.

Such a distribution board is maintained in a closed state such that a high pressure and a high current flow due to the characteristics of the facility, and thus, people other than the manager cannot easily access or operate the distribution board. That is, the distribution board is generally stored in a metal box.

Meanwhile, since such a distribution board serves to receive and distribute electric power in a state of being stored in the metal box as described above, in order to check whether such operations are smoothly performed from the outside, it is inconvenient that the manager must enter and check the inside through an opening and closing hole of the box. In addition, since it is difficult to easily check the status of the distribution board from the outside or in real time, there is a problem in that if a fire occurs, the distribution board cannot be replaced immediately.

Accordingly, in recent years, smart distribution boards have been developed in which an electronic sensor is mounted on the distribution board to monitor; measure and control an amount of power consumption in real time.

However, since the replacement ratio of the existing distribution board to the smart distribution board is relatively small to date, a tire risk is relatively high, and thus, the situation is that the fire occurrence rate of the distribution board and the insurance damage rate of fire insurance companies are relatively high.

### SUMMARY

An object of the present disclosure is to lower the insurance loss ratio by attracting customers with low fire risk by discounting the fire insurance premiums of the users who introduce a lot of smart distribution boards and frequently inspect distribution boards.

In addition, an object of the present disclosure is to lower the insurance loss ratio by attracting customers with low fire risk by discounting fire insurance premiums of the users with a low fire risk of distribution boards.

The technical problems to be solved by the present disclosure are not limited to the above-described technical problems, and other technical problems that are not described above will be clearly understood by those skilled in the art from the following description.

In order to solve the problems as described above, the present disclosure provides a device for calculating a fire insurance premium discount rate for a distribution board which is a device for calculating a discount rate for a fire insurance premium applied to a distribution board and providing the same to an insurance company server, including a control unit for receiving distribution board information from the distribution board and controlling the distribution board, and a discount rate calculation unit for receiving, from the insurance company server, fire insurance premium information applied to the distribution board, and calculating a discount rate of the fire insurance premium on the basis of the distribution board information and the fire insurance premium information.

Herein, the discount rate calculation unit transmits the discount rate for a fire insurance premium to the insurance company server such that the insurance company server applies the discount rate to the fire insurance premium.

In addition, the distribution board information includes smart distribution board introduction and operational status information of the distribution board.

Herein, the smart distribution board introduction and operational status information of the distribution board includes a smart distribution board replacement ratio of the distribution board, whether a smart distribution software of the control unit is installed, the utilization form of the smart distribution software, a smart distribution circuit breaker replacement ratio of the distribution board and a measurement sensor addition ratio.

In addition, the fire insurance premium information includes calculation items corresponding to the smart distribution introduction and operational status information, reference scores that vary depending on the degree of the smart distribution introduction and operational status for each calculation item, weights corresponding to the importance of the calculation items and adjustment coefficients for adjusting the discount rate.

In addition, the distribution rate calculation unit calculates a calculation score for each calculation item based on the reference score according to the degree of the smart distribution board introduction and operational status of the distribution board, and calculates the discount rate by applying the weight for each calculation item to the calculation score.

In addition, the discount rate calculation unit calculates the discount rate by multiplying the average of values obtained by multiplying the calculation score by the weight by the adjustment coefficient.

In addition, the distribution board information includes status and environment information of the distribution board and event and alarm information generated according to the status and environment of the distribution board.

In addition, the fire insurance premium information includes risk items corresponding to the status and environment information of the distribution board, risk criteria scores corresponding to the fire risk of the risk items and adjustment coefficients for adjusting the discount rate.

In addition, the discount rate calculation unit calculates an occurrence score indicating the frequency of occurrence of the risk item for each risk item based on the event and alarm information, and calculates the discount rate by applying the risk criteria score for each risk item to the occurrence score.

Herein, the occurrence score is a value having a range between a certain negative number and positive number, and as it is closer to the negative number, the occurrence frequency of the risk item is lower, and as it is closer to the positive number, the occurrence frequency of the risk item is higher.

In addition, the risk criteria score is calculated based on the likelihood of a fire due to the risk item and the degree of fire impact of the risk item.

In addition, the discount rate calculation unit calculates the discount rate by multiplying the sum of values obtained by multiplying the risk criteria score by the occurrence score by the adjustment coefficient.

In addition, the device for calculating a fire insurance premium discount rate for a distribution board according to the present disclosure further includes a display unit for displaying at least one of the distribution board information, the fire insurance premium information and a discount rate of the fire insurance m.

According to the present disclosure, by monitoring the status and the environment of a distribution board in real time, determining whether there is an abnormality in the status and the environment of the distribution board and providing alarm information to the user when there is an abnormality, it is possible to help the user to perform maintenance of the distribution board, and it is possible to prevent the breakdown of the distribution board and the occurrence of fire in advance.

In addition, according to the present disclosure, the fire insurance company can reduce the insurance loss ratio by attracting customers with low fire risk by discounting fire insurance premiums for the users who introduce a lot of smart distribution boards and frequently inspect distribution boards, and at the same time, it is possible to induce the users to actively introduce smart distribution boards to receive discounts on the fire insurance premium.

In addition, according to the present disclosure, the fire insurance company can reduce the insurance loss ratio by attracting customers with low fire risk by discounting the fire insurance premium of the users with a low fire risk of the distribution board, and at the same time, it is possible to induce the users to actively introduce smart distribution boards to receive discounts on the fire insurance premium. The effects of the present disclosure are not limited to those mentioned above, and other effects that are not mentioned may be clearly understood by those skilled in the art from the following description.

### BRIEF DESCRIPTION OF THE DRAWINGS

FIG. 1 is a schematic block diagram of the device for calculating a fire insurance premium discount rate for a distribution board according to an exemplary embodiment of the present disclosure.

FIGS. 2 and 3 are operational flowcharts of the device for calculating a fire insurance premium discount rate for a distribution board according to an exemplary embodiment of the present disclosure.

FIG. 4 is an exemplary risk-level graph used to calculate a risk criteria score according to an exemplary embodiment of the present disclosure.

### DETAILED DESCRIPTION

In order to fully understand the configuration and effects of the present disclosure, preferred exemplary embodiments of the present disclosure will be described with reference to the accompanying drawings. However, the present disclosure is not limited to the exemplary embodiments disclosed below and may be embodied in various forms, and various modifications may be made. However, the description of the present exemplary embodiment is provided so that the disclosure of the present disclosure is complete, and to fully inform the scope of the disclosure to those of ordinary skill in the art to which the present disclosure pertains. In the accompanying drawings, components are illustrated by enlarging in size than actual for the convenience of description, and the ratios of each component may be exaggerated or reduced.

Terms such as ‘first’ and ‘second’ may be used to describe various components, but the components should not be limited by the above terms. The above terms may be used only for the purpose of distinguishing one component from another. For example, without departing from the scope of the present disclosure, a ‘first component’ may be termed a ‘second component’, and similarly, a ‘second component’ may also be termed a ‘first component’. In addition, the singular expression includes the plural expression unless the context clearly dictates otherwise. Unless otherwise defined, terms used in the exemplary embodiments of the present disclosure may be interpreted as meanings commonly known to those of ordinary skill in the art.

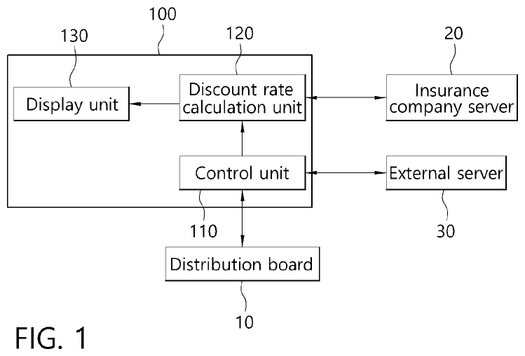

FIG. 1 is a schematic block diagram of the device for calculating a fire insurance premium discount rate for a distribution board according to an exemplary embodiment of the present disclosure.

As illustrated in FIG. 1, the device 100 for calculating a fire insurance premium discount rate for a distribution board according to an exemplary embodiment of the present disclosure calculates a discount rate for a fire insurance premium applied to a distribution board 10 and provides the same to an insurance company server 20, and it may be configured to include a control unit 110, a discount rate calculation unit 120 and a display unit 130.

The control unit 110 receives distribution board information (e.g., the internal temperature of a distribution board) from the distribution board 10 and receives external information (e.g., weather information) from an external server 30 to monitor the distribution board in real time, and controls the distribution board 10 according to a control request of the user (e.g., the manager of the distribution board 10).

The distribution board 10 is provided with a circuit breaker, a relay, a measuring instrument and various sensors therein.

Meanwhile, the smart distribution board means a distribution board that mounts a sensor on the distribution board 10 to monitor the power consumption and the status of the distribution board 10 in real time, and provides event and alarm information according to the monitoring result, and the smart distribution software means application software installed in the control unit 110 to provide the monitoring function of a smart distribution board and event and alarm information.

The distribution board information may include first to third distribution board information. Herein, the first distribution board information includes the status and environment information of the distribution board 10, the second distribution board information includes smart distribution board introduction and the operational status information of the distribution board 10, and the third distribution board information may include event and alarm information.

Specifically, the first distribution board information may include the status information (e.g., normal operation, malfunction, etc.) of devices provided inside the distribution board 10 and the information of the environment (e.g., temperature, humidity, etc.) inside the distribution board 10 measured through various sensors.

In addition, the second distribution board information may include a smart distribution board replacement ratio of the distribution board 10, whether the smart distribution software of the control unit 110 is installed, the utilization form of the smart distribution software, a smart circuit breaker replacement ratio of the distribution board 10 and a measurement sensor addition ratio.

In addition, the third distribution board information is generated according to the status and environment of the distribution board 10. For example, the control unit 110 generates event information when the property of a device provided inside the distribution board 10 is changed or the control of a device is performed, and when the temperature inside the distribution board 10 exceeds a reference value or a circuit breaker trip has occurred, alarm information may be generated.

The discount rate calculation unit 120 receives fire insurance premium information applied to the distribution board 10 from the insurance company server 20 and calculates a discount rate of the fire insurance premium applied to the distribution board 10.

The fire insurance premium information may include first and second fire insurance premium information.

Herein, the first fire insurance premium information may include calculation items corresponding to the smart distribution board introduction and operational status information, reference scores that vary depending on the degree of smart distribution board introduction and the operational status for each calculation item, weights corresponding to the importance of the calculation item and adjustment coefficients for adjusting a discount rate.

In addition, the second fire insurance premium information may include risk items corresponding to the status and environment information of the distribution board 10, risk criteria scores corresponding to a fire risk of the risk item and adjustment coefficients for adjusting a discount rate.

The above-described fire insurance premium information is stored in the insurance company server 20 and may be added, changed or deleted thereafter.

The discount rate calculation unit 120 calculates a discount rate of the fire insurance premium based on the distribution board information received from the distribution board 10 and the fire insurance premium information received from the insurance company server 20.

The discount rate calculation unit 120 transmits the calculated discount rate of the fire insurance premium to the insurance company server 20, and the insurance company server 20 applies the received discount rate to the fire insurance premium.

The display unit 130 receives the distribution board information from the control unit 110 and receives the fire insurance premium information and the discount rate of the fire insurance premium from the discount rate calculation unit 120, and displays at least one of the distribution board information, the fire insurance premium information and the discount rate of the fire insurance premium.

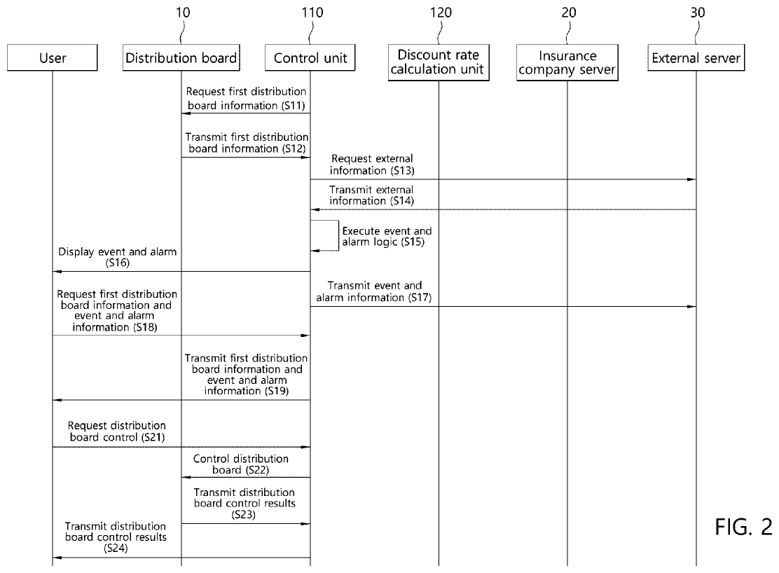

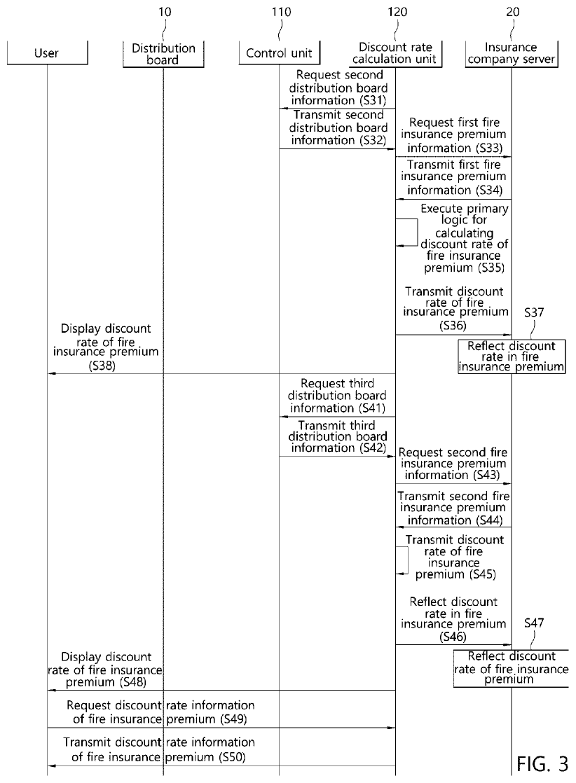

FIGS. 2 and 3 are operational flowcharts of the device for calculating a fire insurance premium discount rate for a distribution board according to an exemplary embodiment of the present disclosure.

Hereinafter, with reference to FIGS. 2 and 3, the operation of the device 100 for calculating a fire insurance premium discount rate for a distribution board according to an exemplary embodiment of the present disclosure will be described. First, referring to FIG. 2, when the control unit 110 requests first distribution board information (e.g., the internal temperature of a distribution board) from the distribution board 10 (S11), the distribution board 10 transmits the first distribution board information to the control unit 110 (S12). In addition, when the control unit 110 requests external information (e.g., weather information) from the external server 30 (S13), the external server 30 transmits the external information to the control unit 110 (S14).

Next, the control unit 110 performs event and alarm logic based on the received first distribution board information and external information (S15). Specifically, the control unit 110 determines whether there is an abnormality in the status and environment of the distribution board 10 according to the first distribution board information and external information, and generates event information if it is normal and generates alarm information if it is abnormal.

Next, the control unit 110 transmits the generated event and alarm information to the external server 30, and the external server 30 transmits the event and alarm information to the user by using e-mail, short message service (SMS), social network service (SNS) or the like.

In addition, the control unit 110 displays (e.g., a pop-up) the generated event and alarm information on the display unit 130 such that the user may recognize the same (S16).

If necessary, the user may request the first distribution board information and event and alarm information from the control unit 110 through an input unit (not illustrated) (S18). Then, the control unit 110 may transmit the requested first distribution board information and event and alarm information to be displayed on the display unit 130 (S19).

As described above, the device 100 for calculating a fire insurance premium discount rate for a distribution board according to an exemplary embodiment of the present disclosure monitors the status and environment of the distribution board 10 in real time, and determines whether there is an abnormality in the status and environment of the distribution board 10, and if it is abnormal, it provides alarm information to the user such that it is possible to help the user to perform maintenance of the distribution board and to prevent malfunction and fire of the distribution board in advance.

Again, referring to FIG. 2, when the user requests the control of the distribution board 10 from the control unit 110 (S21), the control unit 110 controls the distribution board 10 according to the user's request (S22), and the distribution board 10 transmits the control execution result to the control unit 110 (S23). In addition, the control unit 110 may transmit the control execution result, display the same on the display unit 130 and allow the user to recognize the same (S24).

Hereinafter, the method for calculating the discount rate for a fire insurance premium based on the smart distribution board introduction and the operational status of the distribution board 10 will be described.

First, referring to FIG. 3, when the discount rate calculation unit 120 requests the second distribution board information from the control unit 110 (S31), the control unit 110 transmits the second distribution board information to the discount rate calculation unit 120 (S32). In addition, when the discount rate calculation unit 120 requests the first fire premium information from the insurance company server 20 (S33), the insurance company server 20 transmits the first fire insurance premium information to the discount rate calculation unit 120 (S34).

Herein, the second distribution board information may include the smart distribution board introduction and operational status information of the distribution board 10, that is, a smart distribution board replacement ratio of the distribution board 10, whether the smart distribution software of the control unit 110 is installed, the utilization form of the smart distribution board software, a smart circuit breaker replacement ratio of the distribution board 10 and a measurement sensor addition ratio.

In addition, the first fire insurance premium information may include calculation items corresponding to the smart distribution board introduction and operational status information, reference scores that vary depending on the degree of smart distribution board introduction and the operational status for each calculation item, weights corresponding to the importance of the calculation item and adjustment coefficients for adjusting a discount rate.

For example, the reference score may be set to be lowered by 10 points step by step based on 100 points with the highest degree of smart distribution board introduction and operation, and the weight may be set as 1 for medium, 1.5 for high and 0.5 for low, when the importance of the calculation item is classified into high, medium and low, and the adjustment coefficient may be set in the range of 0 to 1.

Next, the discount rate calculation unit 120 performs a primary logic for calculating the discount rate for a fire insurance premium based on the received second distribution board information and the first fire insurance information (S35).

Herein, the primary logic for calculating the discount rate for a fire insurance premium is a logic of calculating the discount rate to be higher as more smart distribution boards are introduced into the distribution board 10, and calculating the discount rate to be higher as the user frequently inspects the distribution board. Specifically, as the smart distribution board replacement ratio is higher, the distribution board 10 may be operated more safely, and by installing smart distribution software and monitoring the switchboard 10 in real time through this software to provide event and alarm information, it is possible to facilitate the user's facility maintenance, and as the frequency of the user checking the event and alarm information is higher, the user's facility inspection frequency becomes higher, and thus, the risk of fire in the switchboard 10 is lowered.

In addition, as the smart circuit breaker replacement ratio is higher, the enhanced management of the distribution board 10 is possible, and as more measurement sensors are added, the environmental monitoring of the distribution board 10 may become stronger, and thus, the risk of fire is lowered.

Therefore, the fire insurance company may lower the insurance loss ratio by attracting customers with low fire risk by discounting fire insurance premiums for the users who introduce a lot of smart distribution boards and frequently inspect distribution boards. At the same time, it is possible to induce the users to actively introduce smart distribution boards to receive discounts on fire insurance premiums.

The discount rate calculation unit 120 calculates the calculation score for each calculation item based on the reference score according to the smart distribution board introduction and operational status of the distribution board 10, and calculates the discount rate by applying a weight to the calculation score for each calculation item.

Specifically, the discount rate calculation unit 120 calculates the discount rate (%) by multiplying the average of values obtained by multiplying the calculated score (Itemₖ) by the weight value (Priorityₖ) by the adjustment factor (AdjFactor) as shown in Mathematical Formula 1 below. Herein, N is the number of calculation items.

$$Discount rate ( \% ) = ( {\sum }_{k = 1}^{N} {Item}_{k} * {Priority}_{k} ) / N * AdjFactor \qquad [ Mathematical Formula 1 ]$$

Table 1 below is a table illustrating a process of exemplarily calculating the discount rate for a fire insurance premium using Mathematical Formula 1 above.

TABLE 1

| Calculation | Reference | Calculation | | | Adjustment |
|---|---|---|---|---|---|
| item | score | score | Importance | Weight | coefficient |
| [Smart distribution | [100] | 70 | Medium | 1.0 | 0.5 |
| board replacement ratio] | | | | | |
| 100% or more replaced | 100 | | | | |
| 50% or more replaced | 90 | | | | |
| 30% or more replaced | 70 | | | | |
| 10% or more replaced | 50 | | | | |
| [Smart distribution | [100] | 100 | High | 1.5 | |
| board replacement ratio] | | | | | |
| Installed | 100 | | | | |
| [Utilization form of smart | [100] | 50 | High | 1.5 | |
| distribution software] | | | | | |
| Real-time inspection | 100 | | | | |
| Routine inspection | 90 | | | | |
| Weekly inspection | 70 | | | | |
| Monthly inspection | 50 | | | | |
| [Smart circuit breaker | [100] | 80 | Medium | 1.0 | |
| replacement ratio] | | | | | |
| 100% or more replaced | 100 | | | | |
| 50% or more replaced | 90 | | | | |
| 30% or more replaced | 70 | | | | |
| 10% or more replaced | 50 | | | | |
| [Measurement sensor | [100] | 60 | Medium | 1.0 | |
| addition ratio] | | | | | |
| 50% or more added | 100 | | | | |
| 30% or more added | 80 | | | | |
| 10% or more added | 60 | | | | |

| | |
|---|---|
| Calculation method | ((70 × 1.0) + (100 × 1.5) + (50 × 1.5) + (80 × 1.0) + (80 × 1.0))/ |
| | 6 × 0.5 = 36.25% |

Referring to Table 1, it can be confirmed that the discount rate for a fire insurance premium is calculated as 36.25%.

Next, the discount rate calculation unit 120 transmits the calculated discount rate for the fire insurance premium to the insurance company server 20 (S36). Then, the insurance company server 20 may reflect the discount rate to the fire insurance premium (S37) and transmit the result to the discount rate calculation unit 120. Then, the discount rate calculation unit 120 may transmit the discount rate of the fire insurance premium, display the same on the display unit 130 (e.g., a pop-up) and allow the user to recognize the same (S38).

Hereinafter, the method will be described in which the distribution board 10 introduces a smart distribution board and operates the smart power distribution software for a certain period of time to evaluate the fire risk based on the collected history information and to calculate the discount rate for a fire insurance premium based on the evaluation result.

First, when the discount rate calculation unit 120 requests the third distribution board information from the control unit 110 (S41), the control unit 110 transmits the third distribution board information to the discount rate calculation unit 120 (S42). In addition, when the discount rate calculation unit 120 requests the second fire premium information from the insurance company server 20 (S43), the insurance company server 20 transmits the second fire insurance premium information to the discount rate calculation unit 120 (S44).

Herein, the third distribution board information may include event and alarm information generated according to the status and environment of the distribution board 10.

In addition, the second fire insurance premium information may include risk items corresponding to the status and environment information of the distribution board 10, risk criteria scores corresponding to a fire risk of the risk item and adjustment coefficients for adjusting a discount rate.

Next, the discount rate calculation unit 120 performs a secondary logic for calculating the discount rate for a fire insurance premium based on the received third distribution board information and first fire insurance premium information (S45).

Herein, the secondary logic for calculating the discount rate for a fire insurance premium evaluates the fire risk of the distribution board 10 and calculates the discount rate to be higher as the fire risk of the distribution board 10 is lower, and as the fire risk of the distribution board 10 is higher, the discount rate is calculated to be higher.

Accordingly, the fire insurance company may lower the insurance loss ratio by attracting customers with low fire risk by discounting the fire insurance premium of the users with a low fire risk of the distribution board 10. At the same time, it may induce the users to actively introduce smart distribution boards to receive discounts on fire insurance premium.

Specifically, the discount rate calculation unit 120 calculates the occurrence score indicating the occurrence frequency of the risk item for each risk item based on the event and alarm information, and calculates the discount rate by applying the risk criteria score for each risk item to the occurrence score.

Herein, the occurrence score is a value having a range (e.g., −1 to 1) between a certain negative number and positive number, and as it is closer to a negative number, the occurrence frequency of the risk item is lower, and as it is closer to a positive number, the occurrence frequency of the risk item is higher.

The risk criteria score is calculated based on the likelihood of a fire caused by the risk item and the fire impact of the risk item.

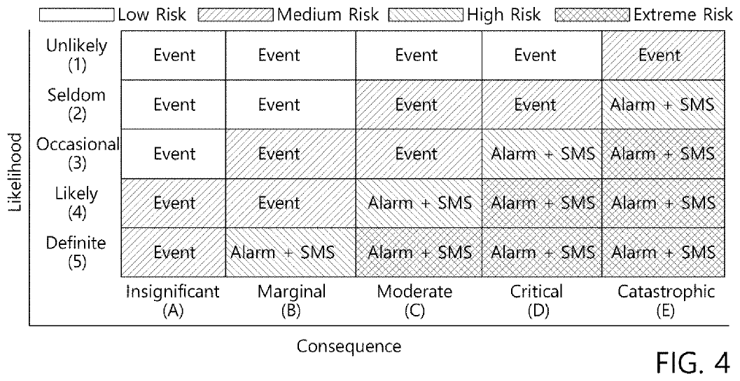

FIG. 4 is an exemplary risk-level graph used to calculate a risk criteria score according to an exemplary embodiment of the present disclosure.

Referring to FIG. 4, the vertical axis represents the likelihood of a fire and the horizontal axis represents the fire consequence.

Herein, the likelihood of a fire (Likelihood) may be classified by stages in the order of low probability. For example, it may be classified into level 1 (Unlikely), level 2 (Seldom), level 3 (Occasional), level 4 (Likely) and level 5 (Definite) in the order of the low likelihood of a fire.

In addition, the fire consequence may be classified by stages in the order of the low consequence. For example, it may be classified into stage A (Insignificant), stage B (Marginal), stage C (Moderate), stage D (Critical) and stage E (Catastrophic) in the order of the low fire consequence.

In addition, the level of risk is set by comprehensively considering the likelihood of a fire and the degree of fire consequence. Herein, the level of risk may be classified into stages in the order of low to high. For example, the level of risk may be divided into a low risk level, a medium risk level, a high risk level and an extreme risk level.

The risk criteria score may be calculated by using the risk graph as shown in Table 1 above. For example, as risk criteria scores, the low risk may be set to 30 points, the medium risk may be set to 50 points, the high risk may be set to 70 points, and the extreme risk may be set to 90 points.

The discount rate calculation unit 120 may calculate the discount rate (%) by multiplying the sum of values obtained by multiplying the risk criteria score (Riskₖ) by the occurrence score (Occurrenceₖ) by the adjustment factor (AdjFactor) as shown in Mathematical Formula 2 below. Herein, N is the number of risk items.

$$Discount rate ( \% ) = ( {\sum }_{k = 1}^{N} {Occurrence}_{k} * {Risk}_{k} ) * AdjFactor \qquad [ Mathematical Formula 2 ]$$

Table 2 below is a table showing a process of exemplarily calculating the discount rate for a fire insurance premium using Mathematical Formula 2 above.

TABLE 2

| | | | Risk criteria | Occurrence | Risk | Adjustment |
|---|---|---|---|---|---|---|
| Risk item | Likelihood | Consequence | score | score | score | coefficient |
| [Communication status] | 3 | D | High Risk(70) | 0.2 | 14 | 0.5 |
| Offline occurs | | | | | | |
| [Thermal imaging sensor] | 3 | D | High Risk(70) | −0.9 | −63 | |
| Over temperature occurs | | | | | | |
| [Temperature sensor] | 3 | D | High Risk(70) | 0.2 | 14 | |
| Over temperature occurs | | | | | | |
| [Phase temperature] | 3 | D | High Risk(70) | −0.5 | −35 | |
| Temperature imbalance occurs | | | | | | |
| [Demand] | 3 | D | High Risk(70) | −0.5 | −35 | |
| Demand excess occurs | | | | | | |
| [Circuit breaker Trip] | 2 | E | High Risk(70) | −0.3 | −21 | |
| Trip occurs | | | | | | |
| [Relay settings] | 2 | E | High Risk(70) | 0.5 | 35 | |
| Relay settings change | | | | | | |
| [System status] | 2 | C | Medium Risk(70) | −0.8 | −40 | |
| Insufficient disk space | | | | | | |
| [Device status] | 1 | E | Medium Risk(70) | 0.2 | 10 | |
| Device error occurs | | | | | | |
| [Device control] | 3 | A | Low Risk(30) | 0.8 | 24 | |
| Control executes | | | | | | |
| [Device properties] | 2 | B | Low Risk(30) | 0.5 | 15 | |
| Properties change | | | | | | |
| [DI/DO status] | 3 | A | Low Risk(30) | 0.5 | 15 | |
| Status changes | | | | | | |

| | | |
|---|---|---|
| Calculation result | −67 | −33.5 |

Referring to Table 2 above, it can be confirmed that the discount rate for a fire insurance premium is calculated as 33.5%.

Next, the discount rate calculation unit 120 transmits the calculated discount rate for the fire insurance premium to the insurance company server 20 (S46). Then, the insurance company server 20 may reflect the discount rate on the fire insurance premium (S47), and transmit the result to the discount rate calculation unit 120. Then, the discount rate calculation unit 120 may transmit the discount rate for the fire insurance premium, display the same on the display unit 130 (e.g., a pop-up) and allow the user to recognize the same (S48).

If necessary, the user may request the discount rate information of the fire insurance premium from the discount rate calculation unit 120 through an input unit (not illustrated) (S49). Then, the discount rate calculation unit 120 may transmit the requested discount rate information and display the same on the display unit 130 (S50).

Although the exemplary embodiments according to the present disclosure have been described above, these are merely exemplary, and those of ordinary skill in the art will understand that various modifications and equivalent ranges of exemplary embodiments are possible therefrom. Accordingly, the true technical protection scope of the present disclosure should be defined by the following claims.

The device for calculating a fire insurance premium discount rate for a distribution board according to the present disclosure may be used in various fields such as smart distribution board servers, insurance company servers and the like.

1. A device for calculating a fire insurance premium discount rate for a distribution board which is a device for calculating a discount rate for a fire insurance premium applied to a distribution board and providing the same to an insurance company server, comprising:
a control unit for receiving distribution board information from the distribution board and controlling the distribution board; and
a discount rate calculation unit for receiving, from the insurance company server, fire insurance premium information applied to the distribution board, and calculating a discount rate of the fire insurance premium on the basis of the distribution board information and the fire insurance premium information.

2. The device of claim 1, wherein the discount rate calculation unit transmits the discount rate for a fire insurance premium to the insurance company server such that the insurance company server applies the discount rate to the fire insurance premium.

3. The device of claim 1, wherein the distribution board information includes smart distribution board introduction and operational status information of the distribution board.

4. The device of claim 3, wherein the smart distribution board introduction and operational status information of the distribution board includes a smart distribution board replacement ratio of the distribution board, whether a smart distribution software of the control unit is installed, the utilization form of the smart distribution software, a smart circuit breaker replacement ratio of the distribution board and a measurement sensor addition ratio.

5. The device of claim 3, wherein the fire insurance premium information includes calculation items corresponding to the smart distribution introduction and operational status information, reference scores that vary depending on the degree of the smart distribution introduction and operational status for each calculation item, weights corresponding to the importance of the calculation items and adjustment coefficients for adjusting the discount rate.

6. The device of claim 5, wherein the distribution rate calculation unit calculates a calculation score for each calculation item based on the reference score according to the degree of the smart distribution board introduction and operational status of the distribution board, and calculates the discount rate by applying the weight for each calculation item to the calculation score.

7. The device of claim 6, wherein the discount rate calculation unit calculates the discount rate by multiplying the average of values obtained by multiplying the calculation score by the weight by the adjustment coefficient.

8. The device of claim 1, wherein the distribution board information includes status and environment information of the distribution board and event and alarm information generated according to the status and environment of the distribution board.

9. The device of claim 8, wherein the fire insurance premium information includes risk items corresponding to the status and environment information of the distribution board, risk criteria scores corresponding to the fire risk of the risk items and adjustment coefficients for adjusting the discount rate.

10. The device of claim 9, wherein the discount rate calculation unit calculates an occurrence score indicating the frequency of occurrence of the risk item for each risk item based on the event and alarm information, and calculates the discount rate by applying the risk criteria score for each risk item to the occurrence score.

11. The device of claim 10, wherein the occurrence score is a value having a range between a certain negative number and positive number, and as it is closer to the negative number, the occurrence frequency of the risk item is lower, and as it is closer to the positive number, the occurrence frequency of the risk item is higher.

12. The device of claim 9, wherein the risk criteria score is calculated based on the likelihood of a fire due to the risk item and the degree of fire impact of the risk item.

13. The device of claim 11, wherein the discount rate calculation unit calculates the discount rate by multiplying the sum of values obtained by multiplying the risk criteria score by the occurrence score by the adjustment coefficient.

14. The device of claim 1, further comprising a display unit for displaying at least one of the distribution board information, the fire insurance premium information and a discount rate of the fire insurance premium.
